(19) United States
(12) Patent Application Publication
(10) Pub. No.: US 2025/0094646 A1
(43) Pub. Date: Mar. 20, 2025

(54) ENHANCING SECURITY FOR CRYPTOGRAPHIC COMPONENTS

(71) Applicant: QUALCOMM Incorporated, San Diego, CA (US)

(72) Inventors: Nicolas Thaddee COURTOIS, Mougins (FR); Matthew MCGREGOR, Huntington Beach, CA (US); Frederic AMIEL, Nice (FR); Florian Reneld Ghislain CAULLERY, Cannes (FR)

(21) Appl. No.: 18/470,311

(22) Filed: Sep. 19, 2023

(51) Int. Cl. G06F 21/72

(52) U.S. Cl. CPC G06F 21/725

(57) ABSTRACT

Systems and techniques for securely performing cryptographic operations are described herein. For example, a process can include obtaining a public data and a security information asset. The process can include performing, by a first computation module, a Boolean operation on the public data and the security information asset to generate an output. The process can include obtaining the public data and the security information asset. The process can include performing, by a second computation module, the Boolean operation on the public data and the security information asset to generate the output. The first computation module has a first configuration and the second computation module has a second configuration, different from the first configuration.

### FIELD

Aspects of the present disclosure relate to systems and techniques for enhancing security for cryptographic components. For example, according to some aspects, the systems and techniques can provide microarchitectures for secure computing systems.

### BACKGROUND

Computing devices often employ various techniques to protect data. As an example, data may be subjected to encryption and decryption techniques in a variety of scenarios, such as writing data to a storage device, reading data from a storage device, writing data to or reading data from a memory device, encrypting and decrypting blocks and/or volumes of data, encrypting and decrypting digital content, performing inline cryptographic operations, etc. Such encryption and decryption operations are often performed, at least in part, using a security information asset, such as a cryptographic key, a derived cryptographic key, etc. Certain scenarios exist in which attacks are performed in an attempt to obtain such security information assets. Accordingly, it is often advantageous to implement systems and techniques to protect such security information assets.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, methods, apparatuses, and computer-readable media for securely performing cryptographic operations.

According to at least one example, a method is provided for securely performing cryptographic operations. The method includes: obtaining a public data and a security information asset; performing, by a first computation module, a Boolean operation on the public data and the security information asset to generate an output; obtaining the public data and the security information asset; and performing, by a second computation module, the Boolean operation on the public data and the security information asset to generate the output, wherein the first computation module has a first configuration and the second computation module has a second configuration, different from the first configuration.

In another example, an apparatus for securely performing cryptographic operations is provided that includes at least one memory and one or more processors coupled to the at least one memory. The one or more processors are configured to: obtain a public data and a security information asset; perform, by a first computation module, a Boolean operation on the public data and the security information asset to generate an output; obtain the public data and the security information asset; and perform, by a second computation module, the Boolean operation on the public data and the security information asset to generate the output, wherein the first computation module has a first configuration and the second computation module has a second configuration, different from the first configuration.

In another example, a non-transitory computer-readable medium is provided that has stored thereon instructions that, when executed by one or more processors, cause the one or more processors to: obtain a public data and a security information asset; perform, by a first computation module, a Boolean operation on the public data and the security information asset to generate an output; obtain the public data and the security information asset; and perform, by a second computation module, the Boolean operation on the public data and the security information asset to generate the output, wherein the first computation module has a first configuration and the second computation module has a second configuration, different from the first configuration.

In another example, an apparatus for performing cryptographic operations is provided. The apparatus includes: means for obtaining a public data and a security information asset; first means for performing a Boolean operation on the public data and the security information asset to generate an output; means for obtaining the public data and the security information asset; and second means for performing the Boolean operation on the public data and the security information asset to generate the output, wherein the first means for performing the Boolean operation on the public data and the security information asset to generate the output has a first configuration and the second means for performing the Boolean operation on the public data and the security information asset to generate the output has a second configuration, different from the first configuration.

In some aspects, one or more of the apparatuses described herein is, is a part of, or includes a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device or system of a vehicle), or other device. In some aspects, the apparatus includes at least one camera for capturing one or more images or video frames. For example, the apparatus can include a camera (e.g., an RGB camera) or multiple cameras for capturing one or more images and/or one or more videos including video frames. In some aspects, the apparatus includes a display for displaying one or more images, videos, notifications, or other displayable data. In some aspects, the apparatus includes a transmitter configured to transmit one or more video frame and/or syntax data over a transmission medium to at least one device. In some aspects, the processor includes a neural processing unit (NPU), a central processing unit (CPU), a graphics processing unit (GPU), or other processing device or component.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 is a block diagram illustrating data flow of security information assets in a computing system, in accordance with some examples of the present disclosure;

FIG. 2 is a block diagram illustrating example cryptographic operations that combine public data with security information assets, in accordance with some examples of the present disclosure;

FIG. 3 is a waveform illustrating how a security operation can reveal specific moments in time where sensitive data are processed, in accordance with some examples of the present disclosure;

FIG. 4A is a block diagram illustrating an example security operation that may introduce vulnerabilities to side channel attacks, in accordance with some examples of the present disclosure;

FIG. 4B is an example electrical circuit model of silicon gates and associated wiring that may introduce electrical leakage vulnerabilities to side channel attacks, in accordance with some examples of the present disclosure;

FIG. 5 is a block diagram illustrating an example secure computing system including cryptographic components with enhanced security, in accordance with some examples of the present disclosure;

FIG. 6A is a block diagram illustrating diversified cryptographic components for performing a cryptographic operation, in accordance with some examples of the present disclosure;

FIG. 6B is an additional block diagram illustrating diversified cryptographic components for performing cryptographic operations with individual key shares, in accordance with some examples of the present disclosure;

FIG. 7 is a block diagram illustrating an example of an architecture for enhancing the security of security operations by calculating n² products from n key shares that that may introduce vulnerabilities to side channel attacks, in accordance with some examples of the present disclosure;

FIG. 8A is a block diagram illustrating an example structure of a bi-linear operation performed on a combination of public data and secret data, in accordance with some examples of the present disclosure;

FIG. 8B is a block diagram illustrating an alternative example structure of a bi-linear operation performed on a combination of public data and secret data with enhanced security relative to the block diagram of FIG. 8A, in accordance with some examples of the present disclosure;

FIG. 9 is a flow diagram illustrating example of a process for performing cryptographic operations, in accordance with some examples of the present disclosure;

FIG. 10 is a diagram illustrating an example of a computing system, in accordance with some examples of the present disclosure.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Cryptographic ciphers can be used for encrypting, decrypting, and/or ensuring authenticity of electronic data. A symmetric cryptographic cipher uses the same key (e.g., referred to as a secret key or a private key) for encryption and decryption. An asymmetric cryptographic cipher uses a private key and a public key shared between parties. A “private key” and a “public key” refer to asymmetric encryption keys, where the private key is known only to a first device (e.g., a peripheral device) and the public key is known to the first device and a second device (e.g., a host device), and to potentially other devices. The second device uses the public key to encrypt data. The first device decrypts the data with the private key. Asymmetric cryptographic ciphers can also be referred to as public-key cryptography (PKC). Examples of symmetric cryptographic ciphers include Advanced Encryption Standard (AES), Data Encryption Standard (DES), Blowfish, Ascon, Keccak, and International Data Encryption Algorithm (IDEA), among various others. In some examples, symmetric ciphers such as AES can be used to implement fast and efficient encryption and decryption. However, because the same key is used for encryption and decryption, the private keys of a symmetric cipher must be distributed to the parties in a way that safeguards the secrecy of the private keys. For example, PKC or asymmetric cipher techniques are often used to perform key distribution for symmetric ciphers (e.g., Diffie-Hellman).

As an example, a security information asset may be a cryptographic key, a sub-key, a secondary key, a derived key, and/or any other security information asset used for encrypting and/or decrypting data and/or ensuring authenticity of data used by a computing device. Such a security information asset may be stored in secure information storage. In one illustrative example, security information assets can include private keys (also referred to herein as secret keys) of a symmetric cryptographic cypher and/or private keys of an asymmetric cryptographic cypher. In some cases, the secure information storage can include a security information asset storage device (e.g., one time programmable (OTP) storage, non-volatile memory device, flash storage device, etc.). Security information assets may be obtained from the security information asset storage device during execution of a computing device (e.g., at boot, reboot and/or during updates), stored in a separate storage device, and provided as needed to security components (e.g., cryptographic engines, key tables, key derivation functions, etc.) for performing security operations (e.g., encryption and/or decryption of data). Security information assets so obtained may be directly used by any number of security components and/or may be used for deriving additional security information assets (e.g., derived keys used by cryptographic engines for encrypting and/or decrypting data), which is an example of a security operation. In some cases, security operations can include other steps or transformations using security information assets without departing from the scope of the present disclosure.

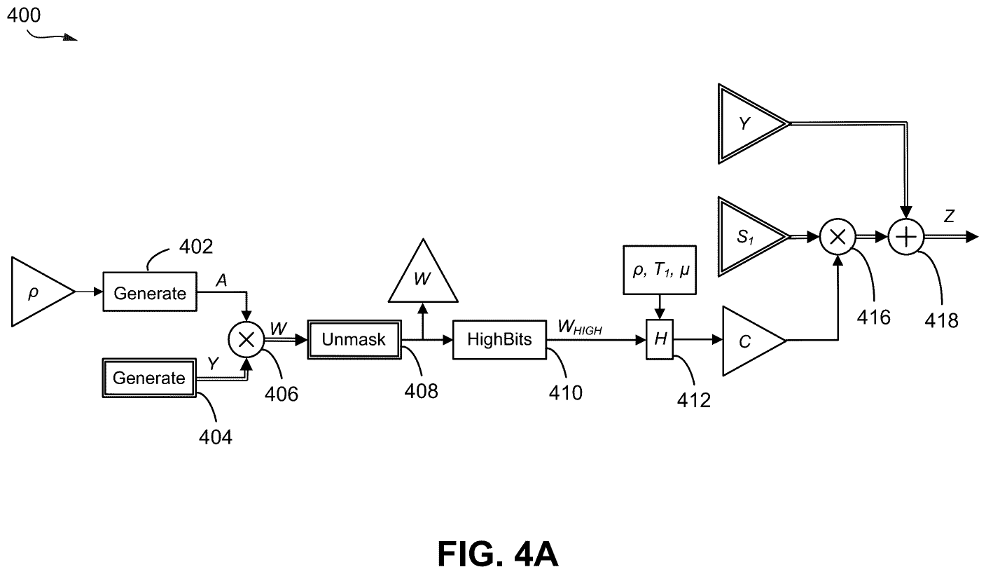

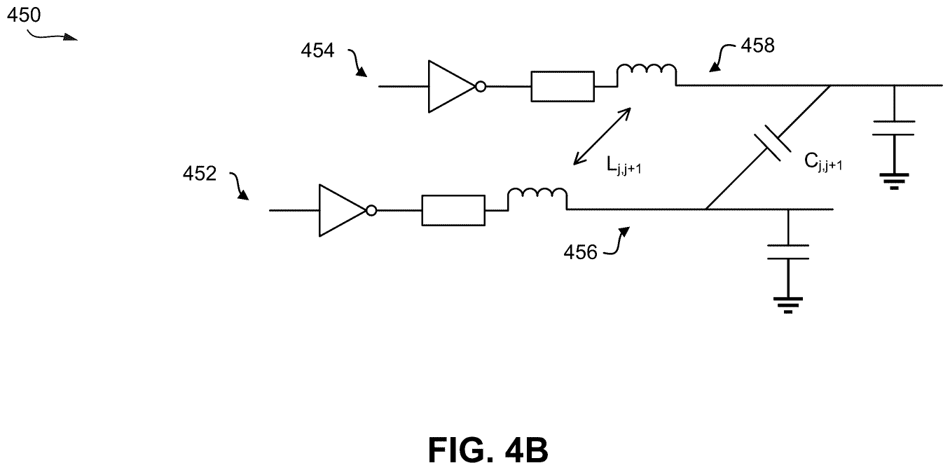

In some cases, a computing system can include multiple identical bi-linear cryptographic components that have an identical trace structure (e.g., as shown in schematic 450 of FIG. 4B). In some cases, an attacker can utilize the self-similarity of different bi-linear cryptographic components to gain information about security information assets in a side-channel attack. As used herein, “self-similarity” refers to the similarity of identical operations performed by different bi-linear cryptographic modules. In some cases, self-similarity of identical operations performed by different bi-linear cryptographic models can be indicative of identical trace structure. In some cases, the traces used in bi-linear cryptographic components can be grouped in a small silicon perimeter. As used herein, “lack of diffusion” refers to the grouping of circuitry used in sensitive operations (e.g., security operations) in a small silicon perimeter. In some cases, self-similarity, lack of diffusion, and/or any combination thereof can be exploited to gain information about security information assets in a side-channel attack.

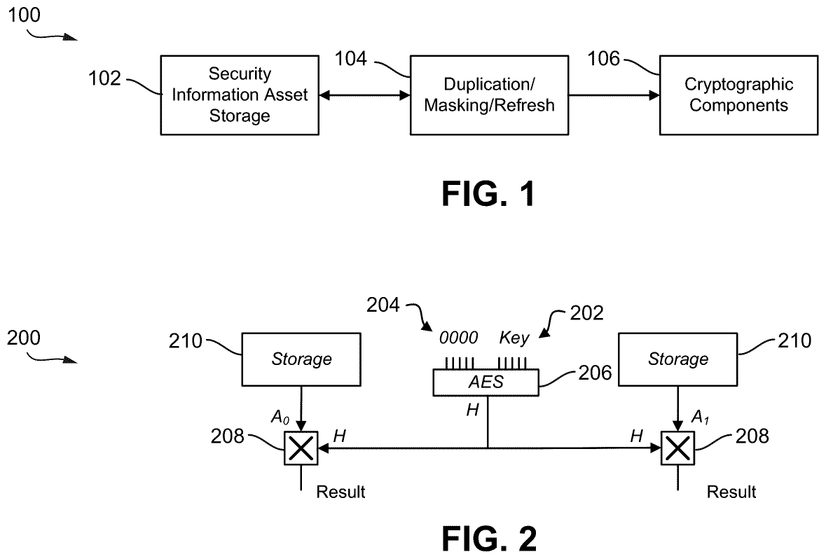

FIG. 1 illustrates a simplified block diagram 100 illustrating data flow of security information assets in a computing system. In some examples, a security information asset is obtained from a security information asset storage device 102. As an example, a security information asset may be obtained from a security information asset storage device 102 when a computing device boots, reboots, and/or updates to be used for various security operations (e.g., encryption and/or decryption operations, key derivation operations, other steps or transformations performed using a security information asset, etc.). In some examples, the security information asset is obtained at a randomizing engine. In some examples, a randomizing engine is any hardware, software, firmware, or any combination thereof that exists within a secure execution environment of a computing device. In some examples, a secure execution environment is any portion of a computing device that is a secure area of the computing device. Examples of secure execution environments include, but are not limited to, trusted management environments, trusted execution environments, trust zones, trusted platform modules, secure components, secure elements, etc. In some examples, the security information asset storage device is a read only storage device, such as a read-only memory device, a one-time programmable storage device, etc. In some examples, the security information asset storage device 102 is a re-programmable storage device such as a non-volatile memory device, a flash storage device, etc. In some examples, a security information asset may be obtained one time from the storage information asset storage device once per boot or reboot of a computing device. A security information asset (e.g., a cryptographic key) may be stored on a security information asset storage device in a masked form or an unmasked form.

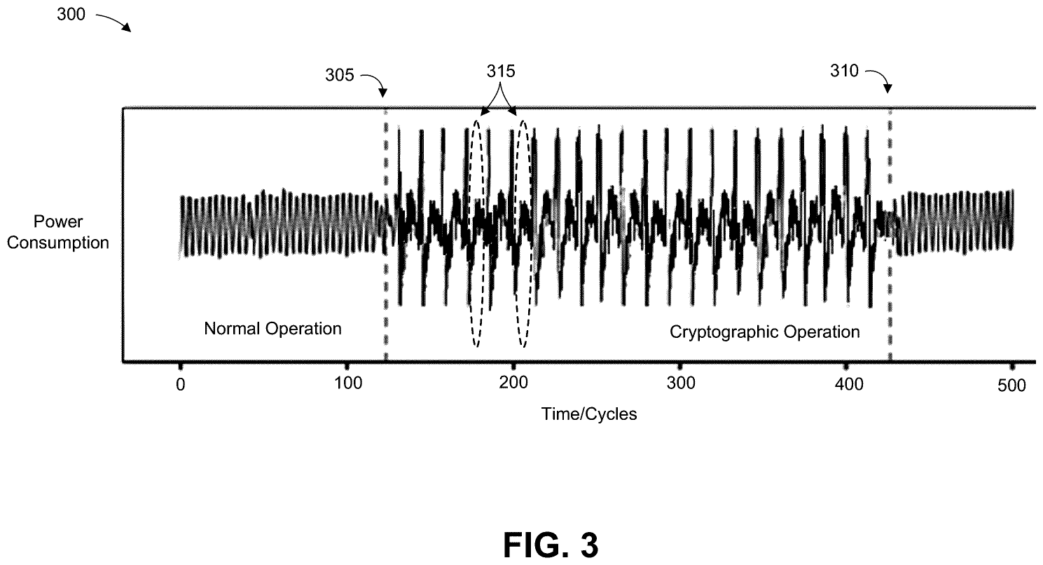

The simplified block diagram 100 illustrates a duplication/masking/refresh module 104 communicatively coupled to security information asset storage device 102. In some cases, the duplication/masking/refresh module 104 can perform duplication of security information assets. For example, the duplication/masking/refresh module 104 can duplicate a variable (e.g., create copies) to be reused at different logic gates. In some cases, the duplicated variable can be used at multiple different times. In some cases, reuse of the duplicated variable can result in repeating patterns 315 as illustrated in FIG. 3.

In some cases, the duplication/masking/refresh module 104 can mask the security information assets obtained from the security information asset storage device 102. As used herein, “masking” refers to a process of obfuscating the content of a data item. Any suitable form of data masking may be used without departing from the scope of examples described herein. In some examples, masking of data refers to altering the data represented in binary form such that if read by any entity not configured to understand the mask applied, the data does not represent the original data (e.g., the security information asset), but that an entity (e.g., a cryptographic engine) configured to be aware of the masking is capable of unmasking, and subsequently using, the original data (e.g., a cryptographic key). Examples of data masking procedures include, but are not limited to, techniques such as substitution, data shuffling, addition of data to the original data, using various parameters (e.g., date, time, etc.) to alter data, splitting and randomizing transmission order of data, splitting the data into separate portions and adding additional data to each (e.g., random numbers), a combination of all or any portion of the aforementioned techniques, etc.

In some examples, the duplication/masking/refresh module 104 can transform and/or recode a security information asset into a different form (e.g., a different data value) that represents the same security information asset. As used herein, “refreshing” refers to ensuring that the form of a security information asset does not remain static. For example, without limitation, a security information asset can be refreshed based on an interval of elapsed time that the information security asset exists in a particular form (e.g., a periodic interval, a pseudo-random interval), based on a number of uses of the security information asset in a particular form, based on storing the security information asset in a new location, on boot, on re-boot, during an update, and/or any combination thereof. In some cases, systematically refreshing the security information asset can help protect the security information asset against discovery by a side channel attack. In some cases, refreshing a security information asset can include changing the values of the security information asset in a way that changes the stored value of the security information asset in the security information asset storage device 102 while still maintaining the security function of the security information asset.

In one illustrative example, a secret key H may be represented by two random values H₁ and H₂ also referred to as “shares” of the secret key H. In some cases, H can be represented as a combination of the shares H₁ and H₂ according to Equation (1) below:

$$H = {H}_{1} XOR {H}_{2} \qquad ( 1 )$$

Where XOR is a bit-wise exclusive OR operation. In some cases, it is preferable to avoid actually performing the calculation shown in Equation (1), which could reveal H in unmasked form.

In some cases, one or more of the shares H₁ and H₂ can be masked in a way that changes the value of each individual share while keeping the result of Equation (1) the same. For example, For example, the duplication/masking/refresh module 104 can mask the share H₁ according to Equation (2a) below:

$${H}_{1 , m} = {H}_{1} XOR {R}_{1} \qquad ( 2 a )$$

Where H_{1,m} is a masked form of H₁ and R₁ is a random value. Similarly, the duplication/masking/refresh module 104 can mask the share H₂ according to Equation (2b) below:

$${H}_{2 , m} = {H}_{2} XOR {R}_{2} \qquad ( 2 b )$$

Where H_{2,m} is a masked form of H₂ and R₂ is a random value. Many different implementations are possible for generating the masked shares H_{1,m} and H_{2,m} as long as the masked shares satisfy Equation (3) below:

$$H = {H}_{1 , m} = {H}_{1} XOR {H}_{2 , m} \qquad ( 3 )$$

It should be understood that the masking operations illustrated in Equation (2a) and Equation (2b) are for the purposes of illustration, and other masking operations can be used without departing from the scope of the present disclosure.

In some cases, one or more of the masked shares H_{1,m} and H_{2,m} can be refreshed to prevent the masked shares H_{1,m} and H_{2,m} from remaining static. For example, the duplication/masking/refresh module 104 can replace the shares H_{1,m} and H_{2,m} with refreshed masked shares H_{1,r} and H_{2,r} in the security information asset storage device 102. Many different implementations are possible for generating the refreshed shares H_{1,r} and H_{2,r} as long as the refreshed shares satisfy Equation (4) below:

$$H = {H}_{1 , r} = {H}_{1} XOR {H}_{2 , r} \qquad ( 4 )$$

Returning to FIG. 1, the duplication/masking/refresh module 104 can distribute security information assets (e.g., shares of a secret key, a secret key, a masked secret key, a derived secret key) to cryptographic components 106. In some cases, the cryptographic components 106 can perform security operations with the security information assets as inputs. In some cases, cryptographic components 106 can perform security operations with a combination of security information assets (e.g., one or more secret keys) and public data. As used herein, “public data” refers to data that is explicitly public (e.g., a public key) and/or data that can be inferred by an attacker based on data that is explicitly public.

In some aspects, as discussed above, security components of a computing device may require a security information asset (e.g., a secret key) to perform one or more security operations (e.g., encrypting and/or decrypting data, generating derivative cryptographic keys, any other steps and or transformations performed using a security information asset, etc.).

However, repeated reuse of security information assets may allow an attacker to use various techniques to obtain all or any portion of a security information asset, which may potentially compromise the security of a computing device. As an example, an attacker may perform a side channel attack by using a measurement device (e.g., an oscilloscope) to measure any number of characteristics of a computing device as it operates (e.g., voltages, power, electromagnetic outputs, timing information, sound, temperature, etc.). As another example, an attacker may employ fault injection techniques. In some cases, an attacker can utilize a machine learning (ML) model (e.g., a deep learning neural network) to aid in a side channel attack.

Such attacks may be of limited use when performed once, or a relatively few number of times, but may have increased effectiveness when performed a larger number of times. As such, security information assets become more vulnerable while being reused when such techniques are being used. As an example, measuring one or more characteristics of the operation of a computing device when operations transferring security information assets are performed, or when performing operations using security information assets, etc. (collectively referred to herein as security operations) may allow an attacker to obtain all or any portion of a security information asset, thereby potentially compromising the security of the computing device.

In some cases, an attacker using a side channel attack or a fault injection attack repetitively as a cryptographic key is being transmitted and/or received (e.g., when obtained from a security information asset storage device at boot time, when obtained from a different storage device, when provided to security components for use in performing security operations, etc.), used to derive other cryptographic keys, etc. may be able to deduce the cryptographic key, and thus be able to use the key to decrypt data on the computing device and/or encrypt potentially malicious data using the correct key, which may then be used by the computing device. In some cases, the derivation of cryptographic keys can include bi-linear operations. For example, derivation of a cryptographic key can include a multiplication of a public key and a private key to generate a derived key.

In some cases, if an attacker can determine the timing of operations transferring security operations, a measurement device can capture characteristics of the computing device at a high resolution on the time scale. In some cases, the amount of data that can be captured by an attacker can be limited by an amount of storage available in a measurement device. In one illustrative example, an oscilloscope may include a measurement buffer (e.g., memory) that can store at most one million measurements. In some cases, if an attacker can determine the timing of a 100 millisecond (ms) security operation within one ms, the measurement time scale can be approximately 100 nanosecond (ns). However, if the timing of the 100 ms operation is unknown to the attacker, the measurement time scale (e.g., 1 microsecond, 10 microseconds, and/or any other suitable timescale) can be significantly longer than the measurement timescale when timing information is known. In some cases, the data transfer, data storage, and/or data processing requirement for longer measurement timescales can be significantly more expensive to store and process on an attacker's device (e.g., a high-order differential power analysis, a deep learning ML attack, or the like) to extract useful information relative to an attack where timing information is known.

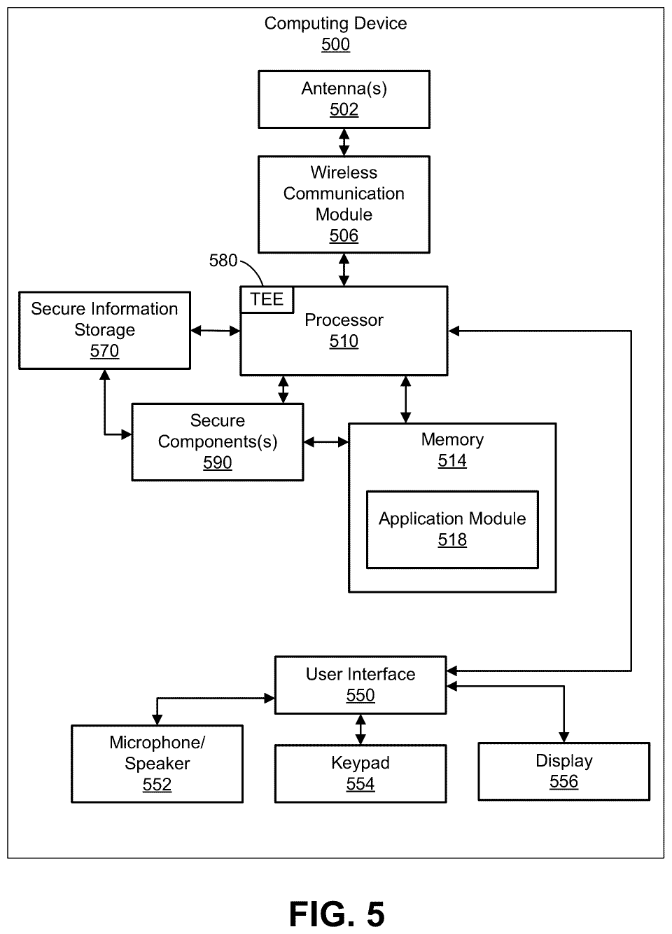

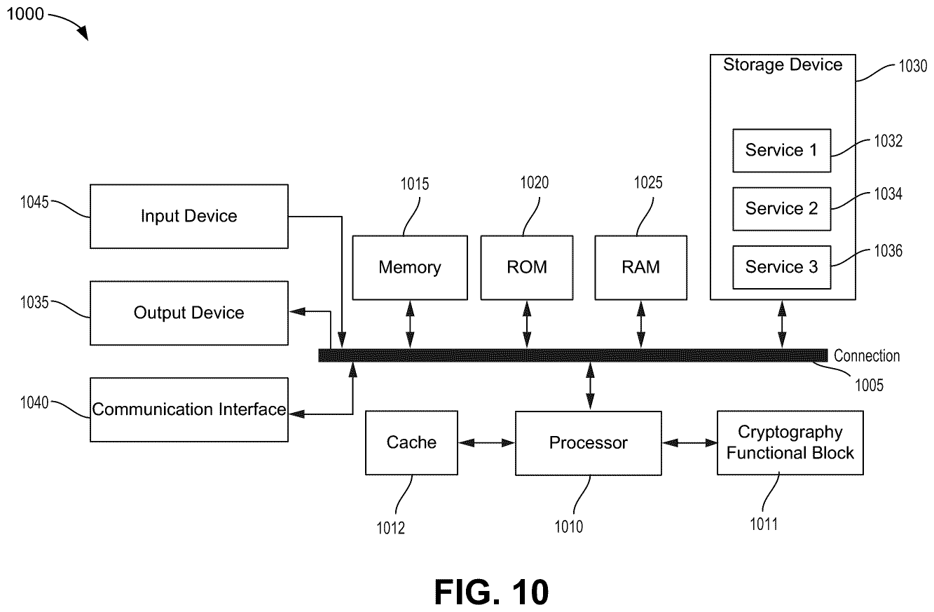

FIG. 2 is a block diagram 200 illustrating example cryptographic operations that combine public data with security information assets. As illustrated in FIG. 2, secret key 202 (e.g., a security information asset) can be input along with a zero data block 204 (e.g., 128-bits all having value “0”) into an AES cipher module 206. As illustrated, the AES cipher module 206 can generate a hash subkey (H) (e.g., a 128-bit value) based on the secret key 202. As illustrated in FIG. 2, H is distributed to two different computation modules 208. In some cases, the computation modules 208 can correspond to cryptographic components 106 of FIG. 1. In the illustrative example, each computation modules 208 can also obtain one or more public data values A₁ (e.g., public data values A₀, A₁) from storage 210 (e.g., system memory 1015, storage device 1030 of FIG. 10, memory 514 of FIG. 5). In one illustrative example, the computation modules 208 can perform a computation based on a public data value Aᵢ and hashed subkey H. In some cases, the public data values Aᵢ for each computation module 208 can be the same public data value or different public data values. In some cases, the computation modules 208 can implement a bi-linear function with respect to the public data value Aᵢ and the hashed subkey H. Illustrative example bi-linear functions include, without limitation, matrix*vector multiplications in Dilithium, AES MixColumns, A*H in GF(2¹²⁸) for an AES-GCM mode, any other bi-linear function, and/or any combination thereof. In some cases, the operations performed by the computation modules 208 of FIG. 2 may occur at different times. In some cases, the structure (e.g., logic gates used, physical arrangement of routing traces) of the computation modules 208 may be identical.

FIG. 3 illustrates a waveform 300 of a security operation that may reveal power consumption and/or timing information to an attacker. For example, an attacker may attempt to analyze the waveform 300 to obtain information about one or more precise moments in time when the most sensitive security information assets are being processed. As illustrated, power fluctuations between a beginning 305 and an end 310 of an AES encryption operation (e.g., a security operation) can differ from power fluctuations before the beginning 305 and after the end 310 of the AES encryption operation. In some cases, security operations may remain identifiable due to reuse of variables (e.g., public keys), self-similarity of operations (e.g., by identical computation modules 208 of FIG. 2) performed at different times, and/or lack of diffusion of components used to perform cryptographic operations outside of a small silicon perimeter, which can result in repeating patterns 315 in the power fluctuations. In some cases, reuse of variables may improve the signal to noise ratio of information obtained in side-channel attacks, which may benefit the attacker. In some examples, lack of diffusion inside cryptographic operations may allow joint combined leakage within a small silicon perimeter to be analyzed by machine learning and/or AI. In some cases, a side channel attack can capture measurements targeted to the small silicon perimeter to avoid interference from outside components.

While an AES encryption option is provided as an example, other security operations, including but not limited to number theoretic transform (NTT) computations, matrix vector multiplication (A*y), r and r.G multiplication (e.g., elliptic curve point multiplication) events (e.g., for an elliptic curve digital signature algorithm (ECDSA)), security hash algorithms, (e.g., SHA-256, SHA-3), McEliece cryptography, bit flipping key encapsulation (BIKE), Hamming quasi-cycling (HQC) encryption, hash-based message authentication code (e.g., HMAC-512), RNG seeding, and/or any combination thereof may also reveal information to an attacker through a side channel attack.

Many techniques have been developed to reduce the vulnerability of security operations. For example, some techniques can include hiding security operations, imposing variable timing, performing specialized operations, adding redundant operations, or the like. In some cases, one or more techniques can be implemented in software executed by a computing system. However, as noted above, in some cases, security operations may remain identifiable due to reuse of variables, self-similarity of operations performed at different times, and/or lack of diffusion of cryptographic operations.

For example, FIG. 4A is a block diagram illustrating an example security operation 400 that may introduce vulnerabilities to side channel attacks. In one illustrative example, the security operation 400 can represent an implementation of the Dilithium signature scheme as described in Migliore et al., “Masking Dilithium: Efficient Implementation and Side-Channel Evaluation,” 2019, Applied Cryptography and Network Security, pp. 344-362, which is hereby incorporated by reference in its entirety and for all purposes. In the example illustration of FIG. 4A, masked functions (e.g., additional generation module 404) and/or variables (e.g., Y, S1) are illustrated with double lines while unmasked functions (e.g., generation module 402, hash function (H) 412) and/or variables (e.g., p, W, C) are illustrated with single lines. As illustrated in FIG. 4A, a generation module 402 generates a variable A based on a publicly available seed p. An additional generation module 404 secretly generates a matrix Y. As illustrated in FIG. 4A, a multiplier 406 multiplies variable A and matrix Y together to generate a masked version of a variable W. In some cases, an unmasking module 408 generates an unmasked version of the variable W. As illustrated, a “HighBits” module 410 outputs the high bits of unmasked variable W. As illustrated, H 412 obtains the high bits of W, seed ρ, derived variable T1, and a message. In some cases, the derived variable T1 can be generated based on the variable A and secret key shares S1, S2. As illustrated, H 412 generates a challenge variable C. As illustrated, the challenge variable C is multiplied by multiplier 416 with secret key share S1 and the result can be added by adder 418 to matrix Y to generate variable Z. In some cases, the multiplication operations by multiplier 406 and multiplier 416 can be implemented by bi-linear cryptographic components. In some implementations, the multiplication operations can mix “public” data with highly sensitive values.

In the illustrated example of FIG. 4A, the unmasked public variables (e.g., A, C) coming from generation module 402 and/or H 412 can be operands in a bi-linear operation may not be protected by masking. As illustrated, there are instances where the unmasked public variables (e.g., variable A, challenge variable C) are combined with masked secret variables (e.g., secret keys, secret key shares, derived key variables, derived key share variables) in bi-linear multiplication operations (e.g., by multiplier 406, multiplier 416). In some cases, the apparent lack of protection of a module performing operations that involve masked secret variables presents an opportunity to develop new countermeasures. For example, defensive counter-measures can be added to bi-linear multipliers 406, 416. In some cases, the same unmasked public variables can be used repeatedly in operations with the masked secret variables. In some cases, the repeated use of the unmasked public variables in bi-linear operations (e.g., multiplication operations) by bi-linear cryptographic components can result in repeating patterns 315 in power consumption that can be exploited to gain information about security information assets in a side-channel attack. In some cases, the greater the frequency of processing masked secret variables (or masked secret variable shares) in bi-linear operations that interact with one or more public variables (e.g., variables known and/or expected to be known in advance by an attacker) the easier it may become for an attacker to discern patterns in power consumption and/or timing during a side channel attack. In some implementations, masking of some or all of the public variables may be used to improve security by preventing an attacker from knowing that the masked variable corresponding to the public variable is being used in one or more operations.

FIG. 4B illustrates an example schematic 450 of two circuits 452, 454 for processing two adjacent data bits inside a cryptographic operation. Many protected implementations protect against first order power analysis and assume that two logically distinct electrical circuits are sufficiently isolated and do not interact. Masking or randomizing all individual bits inside a computation may be sufficient to avoid leaking any useful information to an attacker when the two logically distinct electrical circuits are sufficiently isolated (e.g., by physical separation, shielding, or the like). However, in some cases, pairs of bits inside a cryptographic operation could leak additional information through electrical coupling. In one illustrative example, electrical coupling between bits inside a cryptographic operation can be caused by proximity of two wires (e.g., wires 456, 458 of FIG. 4B). In some cases, electrical coupling can be a mutual capacitive coupling represented in the schematic 450 as Cj,j+1 and/or by mutual inductive coupling represented in the schematic 450 as as Lj,j+1. In some cases, the value of the capacitance Cj,j+1 and/or the inductance Lj,j+1 can be a function of wire geometry and/or distance of the wires 456, 458. In some examples, this coupling interaction can be used to recover the original unmasked secret bit values. In some cases, the two circuits 452, 454 illustrated in schematic 450 may carry two masked bits of a security information asset, inside a particular bi-linear cryptographic component. In one illustrative example, the electrical coupling between wires 456, 458 may reveal information to an attacker if wires 456, 458 happen to carry two masked bits that are processed concurrently in an XOR operation.

In some cases, a computing system can include multiple identical bi-linear cryptographic components that have an identical trace structure to the schematic 450. In some cases, an attacker can utilize the self-similarity of different bi-linear cryptographic components with masked data to gain information about unmasked secret security information assets in a side-channel attack through real-time interaction due to simultaneity and/or various forms of coupling. As used herein, “self-similarity” refers to the similarity of identical operations performed by different bi-linear cryptographic modules. In some cases, self-similarity of identical operations performed by different bi-linear cryptographic models can be indicative of identical trace structure. In some cases, the traces used in bi-linear cryptographic components can be grouped in a small silicon perimeter. In some cases, self-similarity, lack of diffusion, and/or any combination thereof can be exploited to gain information about security information assets in a side-channel attack.

In view of the foregoing, systems and techniques are needed for enhancing the security of cryptographic components (e.g., linear and/or bi-linear components).

Systems, apparatuses, electronic devices, methods (also referred to as processes), and computer-readable media (collectively referred to herein as “systems and techniques”) are described herein for enhancing security in cryptographic components. In some examples, a microarchitecture for secure computing systems (e.g., within a secure execution environment) can be designed with microarchitectural protections that can avoid repeated deterministic usage of sensitive security information assets automatically at the processor level. In some cases, the systems and techniques described herein can be implemented automatically at runtime and at the processor level. For examples, in some implementations, the systems and techniques can be implemented with a rotation between several different multiplier units and/or microcode versions.

Various aspects of the systems and techniques described herein will be discussed below with respect to the figures. According to various examples, FIG. 5 is a diagram illustrating an example computing device 500. The computing device 500 may include, but is not limited to, any of the following: one or more processors (e.g., components that include integrated circuitry, memory, input and output device(s) (not shown), non-volatile storage hardware, one or more physical interfaces, any number of other hardware components (not shown), and/or any combination thereof. Examples of computing devices include, but are not limited to, a mobile device (e.g., laptop computer, smart phone, personal digital assistant, tablet computer, automobile computing system, and/or any other mobile computing device), an Internet of Things (IoT) device, a server (e.g., a blade-server in a blade-server chassis, a rack server in a rack, etc.), a desktop computer, a storage device (e.g., a disk drive array, a fibre channel storage device, an Internet Small Computer Systems Interface (iSCSI) storage device, a tape storage device, a flash storage array, a network attached storage device, etc.), a network device (e.g., switch, router, multi-layer switch, etc.), a wearable device (e.g., a network-connected watch or smartwatch, or other wearable device), a robotic device, a smart television, a smart appliance, an extended reality (XR) device (e.g., augmented reality (AR), virtual reality (VR), etc.), any device that includes one or more SoCs, and/or any other type of computing device with the aforementioned requirements. In one or more examples, any or all of the aforementioned examples may be combined to create a system of such devices, which may collectively be referred to as a computing device. Other types of computing devices may be used without departing from the scope of examples described herein.

As illustrated in FIG. 5, the computing device 500 may include one or more antennas 502, one or more wireless communication modules 506, a processor 510, memory 514, application module 518, user interface 550, microphone/speaker 552, keypad 554, display 556, secure information storage 570, trusted execution environment 580, and secure components 590.

As shown, the computing device 500 may include one or more wireless communication modules 506 that may be connected to one or more antennas 502. The one or more wireless communication modules 506 comprise suitable devices, circuits, hardware, and/or software for communicating with and/or detecting signals to/from an access point, a network, a base station, and/or directly with other wireless devices within a network.

In some implementations, the one or more wireless communication modules 506 may comprise a communication system (e.g., a CDMA system) suitable for communicating with a network (e.g., a CDMA network) of wireless base stations. In some implementations, the wireless communication system may comprise other types of cellular telephony networks, such as, for example, TDMA, GSM, WCDMA, 4G/Long-Term Evolution (LTE), 5G/New Radio (NR), and the like. Additionally, any other type of wireless networking technologies may be used, including, for example, WiMax (802.16), Wi-Fi (802.11), and the like.

The processor(s) (also referred to as a controller) 510 may be connected to the one or more wireless communication modules 506. The processor 510 may include one or more microprocessors, microcontrollers, and/or digital signal processors that provide processing functions, as well as other calculation and control functionality. The processor 510 may be coupled to storage media (e.g., memory) 514 for storing data and software instructions for executing programmed functionality within the mobile device. The memory 514 may be on-board the processor 510 (e.g., within the same IC package), and/or the memory may be external memory to the processor and functionally coupled over a data bus.

A number of software engines and data tables may reside in memory 514 and may be utilized by the processor 510 in order to manage communications, perform positioning determination functionality, and/or perform device control functionality. In some cases, the memory 514 may include an application module 518. It is to be noted that the functionality of the modules and/or data structures may be combined, separated, and/or be structured in different ways depending upon the implementation of the computing device 500.

The application module 518 may include a process running on the processor 510 of the computing device 500, which may request data from one of the other modules of the computing device 500. Applications typically run within an upper layer of the software architectures and may be implemented in a rich execution environment of the computing device 500, and may include indoor navigation applications, shopping applications, financial services applications, social media applications, location aware service applications, etc.

In some examples, the computing device 500 includes the secure information storage 570. In some examples, the secure information storage 570 can be any storage device configured to store security information assets (e.g., cryptographic keys, metadata, etc.). For instance, the secure information storage 570 is where security information assets are stored and initially obtained from when needed for use on a computing device (e.g., for encryption and/or decryption of data). In some cases, the secure information storage 570 can include a key store or a key table. Examples of secure information storage 570 include, but are not limited to, various types of read-only memory, one-time programmable memory devices (e.g., one time programmable fuses or other types of one time programmable memory devices), non-volatile memory, etc. The secure information storage 570 may be operatively connected to the trusted execution environment 580 and/or the secure components 590. Although FIG. 5 shows the computing device 500 as including a single secure information storage 570, the computing device 500 may include any number of secure information storages without departing from the scope of examples described herein.

The processor 510 may include a trusted execution environment 580. The trusted execution environment 580 may also be referred to as a trusted management environment, trust zones, trusted platform modules, or the like. The trusted execution environment 580 can be implemented as a secure area of the processor 510 that can be used to process and store sensitive data in an environment that is segregated from the rich execution environment in which the operating system and/or applications (such as those of the application module 518) may be executed. The trusted execution environment 580 can be configured to execute secure applications (also referred to as trusted applications) that provide end-to-end security for sensitive data by enforcing confidentiality, integrity, and protection of the sensitive data stored therein. The trusted execution environment 580 can be used to store encryption keys, access tokens, and other sensitive data.

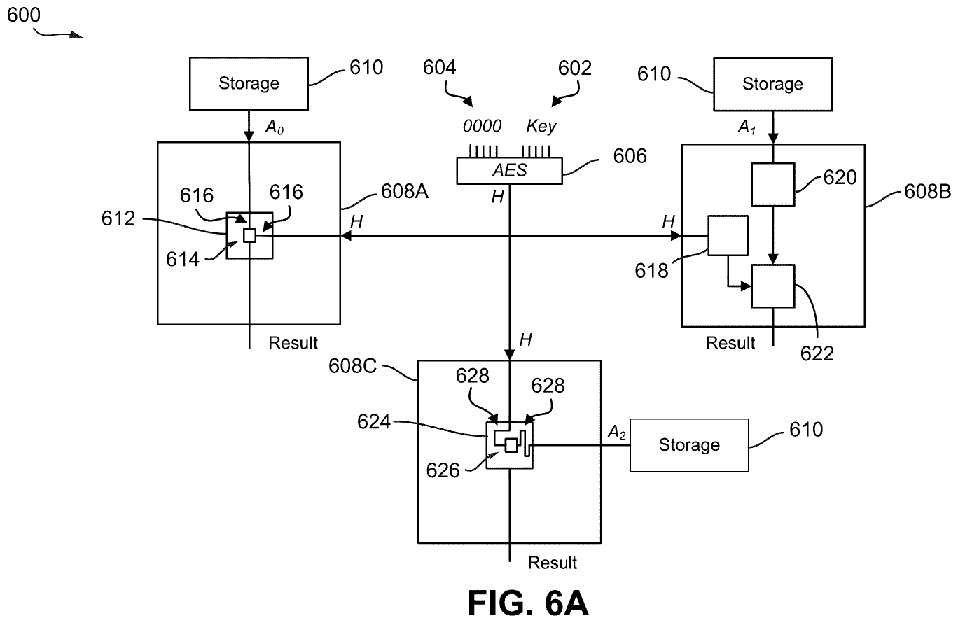

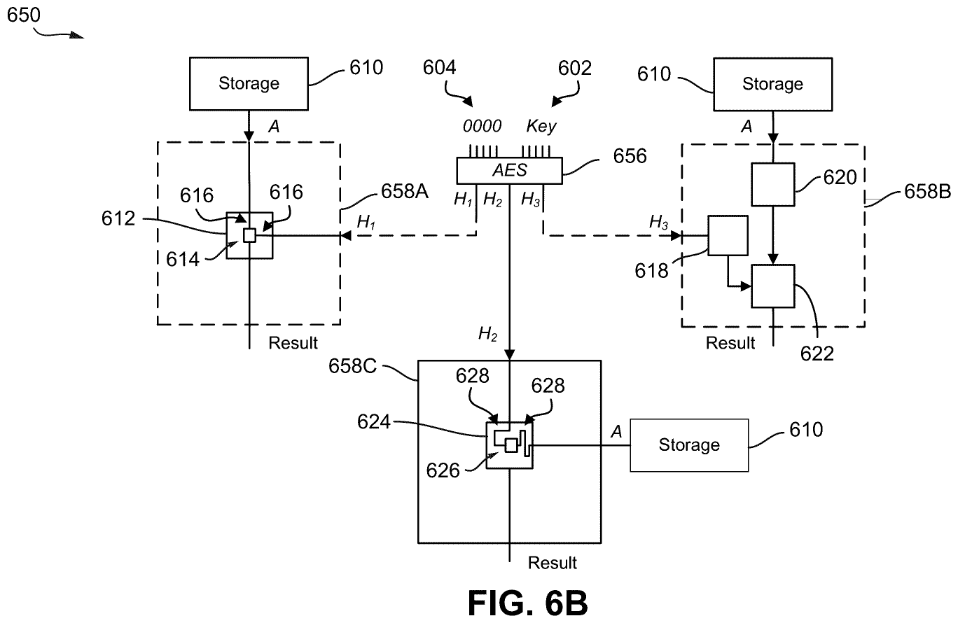

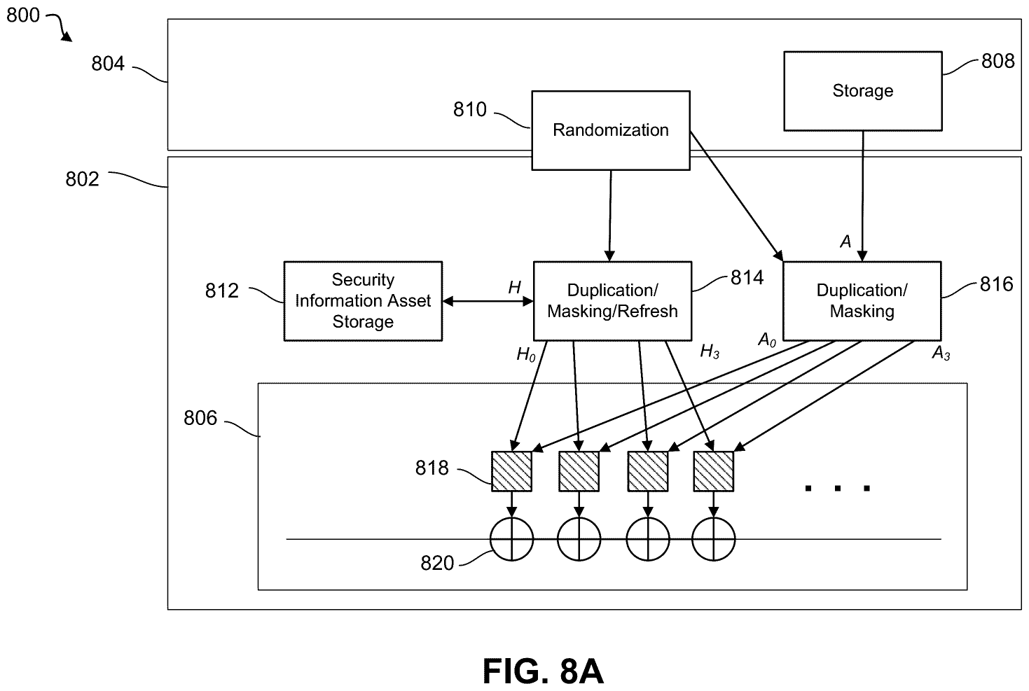

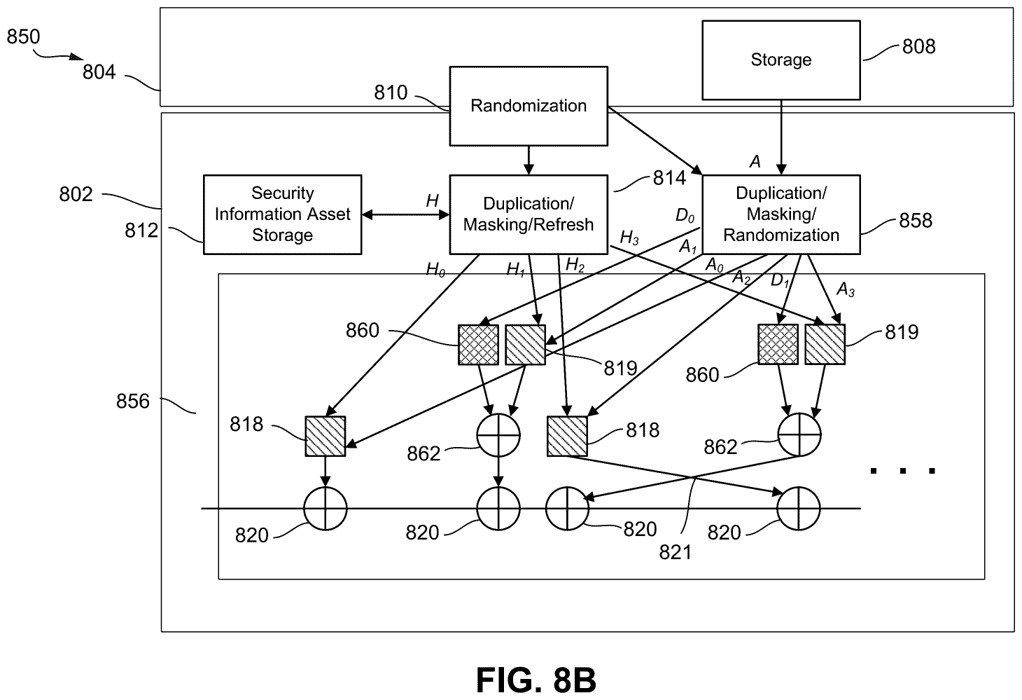

The computing device 500 may include one or more secure components 590 (e.g., computation modules 208 of FIG. 2, computation modules 608A, 608B, 608C of FIG. 6A, computation modules 658A, 658B, 658C of 6B, computation module 806 of FIG. 8A, and/or alternative computation module 856 of FIG. 8B). In some cases, the secure components 590 can be referred to as trusted components, secure elements, trusted elements, or the like. The computing device 500 may include the secure components 590 in addition to or instead of the trusted execution environment 580. The secure components 590 can comprise autonomous and tamper-resistant hardware that can be used to execute secure applications and the confidential data associated with such applications. The secure components 590 can be used to store encryption keys, access tokens, and other sensitive data. The secure components 590 can comprise a Near Field Communication (NFC) tag, a Subscriber Identity Module (SIM) card, or other type of hardware device that can be used to securely store data. The secure components 590 can be integrated with the hardware of the computing device 500 in a permanent or semi-permanent fashion or may, in some implementations, be a removable component of the computing device 500 that can be used to securely store data and/or provide a secure execution environment for applications.

Examples of secure applications that may be performed by the computing device 500, processor 510, secure information storage 570, trusted execution environment 580, secure components 590, and/or any combination thereof include, but are not limited to, encrypting data, decrypting data, key derivation, performing data integrity verification, and performing authenticated encryption and decryption. In some examples, the computing device 500 and/or portions thereof can be configured to perform the various cryptographic service types by being configured to execute one or more cryptographic algorithms. As an example, to perform encryption and decryption, one or more components (e.g., secure information storage 570, trusted execution environment 580, secure components 590) of the computing device 500 may be configured to execute one or more of the Advanced Encryption Standard XOR-encrypt-XOR Tweakable Block Ciphertext Stealing (AES-XTS) algorithm, the AES-Cipher Block Chaining (AES-CBC) algorithm, the AES-Electronic Codebook (AES-EBC) algorithm, the Encrypted Salt-Sector Initialization Vector-AES-CBC (ESSIV-AES-CBC) algorithm, etc., including any variants of such algorithms (e.g., 128 bits, 192 bits, 256 bits, etc.). As another example, to perform integrity verification, one or more components of the computing device 500 may be configured to execute a hash algorithm such as, for example, the one or more members of the SHA family of hash algorithms. As another example, to perform authenticated encryption, one or more components of the computing device 500 may be configured to perform the AES-Galois/Counter Mode (GCM) algorithm. In some aspects, one or more components of the computing device 500 may be configured to execute any other cryptographic algorithms without departing from the scope of examples described herein.

The computing device 500 may further include a user interface 550 providing suitable interface systems, such as a microphone/speaker 552, a keypad 554, and/or a display 556 that allows user interaction with the computing device 500. The microphone/speaker 552 can provide for voice communication services (e.g., using the one or more wireless communication modules 506). The keypad 554 may comprise suitable buttons for user input. The display 556 may include a suitable display, such as, for example, a backlit LCD display, and may further include a touch screen display for additional user input modes.

While FIG. 5 shows a certain number of components in a particular configuration, one of ordinary skill in the art will appreciate that the computing device 500 may include more components or fewer components, and/or components arranged in any number of alternate configurations without departing from the scope of examples described herein. Additionally, although not shown in FIG. 5, one of ordinary skill in the art will appreciate that the computing device 500 may execute any amount or type of software or firmware (e.g., bootloaders, operating systems, hypervisors, virtual machines, computer applications, mobile device apps, etc.). Accordingly, examples disclosed herein should not be limited to the configuration of components shown in FIG. 5. The components shown in FIG. 5 may or may not be discrete components. In some aspects, one or more of the components can be combined into different hardware elements, implemented in software, and/or otherwise implemented using software and/or hardware. As used herein, the term device may be a discrete component or apparatus, or may not be a discrete component. In some aspects, other devices can exist within, be part of, and/or utilize the same hardware components as a device.

FIG. 6A is a block diagram 600 illustrating diversified cryptographic components for performing a security operation. In the example of FIG. 6A, a secret key 602 can be similar to and perform similar functions as secret key 202 of FIG. 2, a zero data block 604 can be similar to and perform similar functions as zero data block 204, a AES cipher module 606 can be similar to and perform similar functions as AES cipher module 206, and storage 610 can be similar to and perform similar functions as storage 210 of FIG. 2.

As shown in FIG. 6A, a hash subkey (H) (e.g., a security information asset) can be shared with three computation modules 608A, 608B, 608C. Computation modules 608A, 608B, 608C can each perform an identical logical function. In one illustrative example, all three computation modules 608A, 608B, 608C can be configured to calculate A*H in GF(2¹²⁸) of AES-GCM. In some cases, for the same public inputs Aᵢ (e.g., A₀, A₁, A₂), H, each of the computation modules 608A, 608B, 608C can produce an identical result. However, as illustrated in FIG. 6A, the internal structure (e.g., logic gates, routing traces, etc.) of each computation modules 608A, 608B, 608C can be diversified using different microarchitectures. In some cases, diversification of structure within the computation modules 608A, 608B, 608C can reduce the ability of a side channel attack to detect similarities between operations that produce the same result when presented with the same inputs. In some cases, the public inputs Aᵢ multiplied by H in each computation module 608A, 608B, 608C can have be the same or different public values.

As illustrated in FIG. 6A, the computation module 608A includes a logic gate 612. The logic gate 612 can include one or more transistors 614 and traces 616. In some cases, when performing the A*H computation, the computation module 608A can exhibit a first power signature, and a first timing between receiving the inputs Aᵢ, H and producing the result.

In the illustrated example, the computation module 608B includes three logic gates 618, 620, 622. In some cases, the logic gates 618, 620 can perform operations on the inputs A, H in a first computation stage and generate intermediate values that are passed to the logic gate 622. As illustrated, the logic gate 622 can perform an operation on the intermediate values to generate the result. In some aspects, when performing the A*H computation, the computation module 608B can exhibit a second power signature, and a second timing between receiving the inputs Aᵢ, H and producing the result. In some cases, the second power signature and/or second timing can be different from the first power signature and/or the first timing. For example, the two-stage operation of computation module 608B may increase the delay between receiving the inputs Aᵢ, H and generating the result relative to the computation module 608A.

As shown in FIG. 6A, the computation module 608B includes a logic gate 624. As illustrated, the logic gate 624 can include one or more transistors 626 and routing traces 628. In the illustrated example, the routing traces 628 are illustrated with meandering paths, unlike the straight line routing traces 616 of the logic gate 612 in computation module 608A. In some cases, when performing the A*H computation, the computation module 608C can exhibit a third power signature, and a third timing between receiving the inputs Aᵢ, H and producing the result. In some cases, the third power signature and/or third timing can be different from the first power signature, the first timing, the second power signature, and/or the second timing. For example, differences between routing traces 616 and routing traces 628 can result in different capacitances, resistances, inductances, conductances, mutual capacitance, and/or mutual inductances (e.g., as illustrated in FIG. 4B), which can in turn result in different signatures between the computation module 608A and computation module 608C.

In some cases, although not shown in FIG. 6A, the structure of computation modules 608A, 608B, 608C can be configured such that the two inputs are not symmetric and that switching the inputs to perform the calculation H*A instead of A*H may have different power signatures and/or timing. In some aspects, asymmetry between inputs may provide another form of diversification that can reduce the effectiveness of side channel attacks.

FIG. 6B is a block diagram 650 illustrating additional diversified cryptographic components for performing a security operation. In the example of FIG. 6B, a modified AES cipher module 656 can produce three shares H₁, H₂, H₃, of H. As illustrated in FIG. 6B, a public variable A can be multiplied by H₂ in the computation module 658B. In some implementations, A can optionally be multiplied by H₁ in the computation module 658A. In some implementations, A can optionally be multiplied by H₃ in the computation module 658C. Although the configuration illustrated in FIG. 6B does not show public key A being multiplied by the same secret key in each of the computation modules, 658A, 658B, 658C, the configuration illustrated in FIG. 6B can benefit from diversification of the computation modules 658A, 658B, 658C as described with respect to computation modules 608A, 608B, 608C of FIG. 6A. It should be understood that the static diversification described with respect to computation modules 608A, 608B, 608C of FIG. 6A can be applied to other cryptographic component configurations implements multiplications between public data and security information assets without departing from the scope of the present disclosure.

It should be understood that the computation modules 608A, 608B, 608C of FIG. 6A and computation modules 658A, 658B, 658C FIG. 6B are simplified for the purposes of illustration and that computation modules containing more of fewer logic gates and/or traces can be used without departing from the scope of the present disclosure. Although the routing traces 628 are illustrated as meandering paths and the routing traces 616 are illustrated as straight lines, it should be understood that other differences between routing of two logic gates can result in diversification between different computation modules performing an identical computation while remaining within the scope of the present disclosure. The examples of diversification illustrated and described with respect to FIG. 6A and FIG. 6B should not be considered as limiting, and it should be understood that other types of diversification can be used without departing from the scope of the present disclosure.

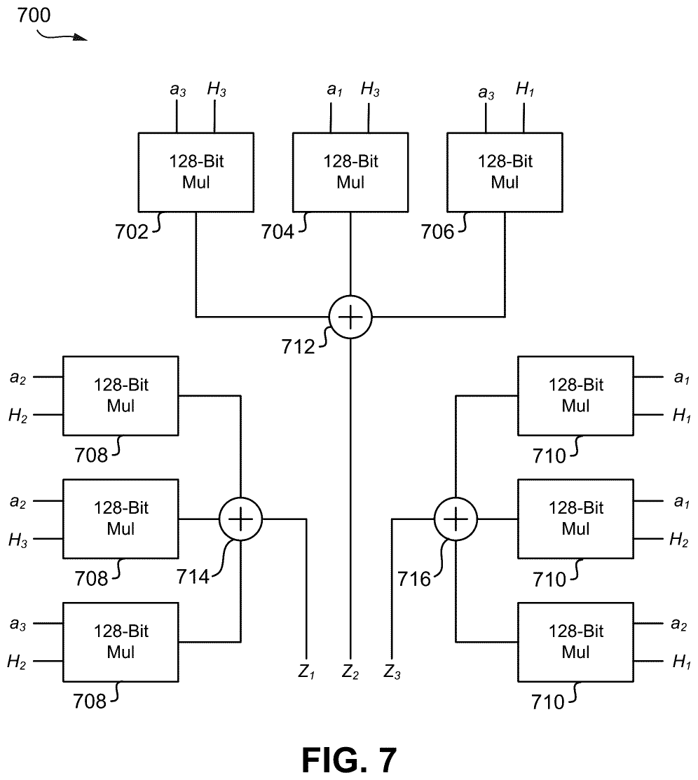

FIG. 7 is a block diagram illustrating an example of an architecture 700 for enhancing the security of security operations by utilizing multiple key shares. In some implementations, the architecture 700 of FIG. 7 can be used to enhance the security of fully masked operations by combining n² products based on n sensitive asset shares H₁ and n public data shares aᵢ, where n is an integer. In the example of FIG. 7, public data “a” can be divided into three public shares (e.g., n=3) a₁, a₂, and a₃. As noted above, in some implementations, masking of the public shares prior to performing the security operations of FIG. 7 can potentially enhance security by making it more difficult for an attacker to know that the known value of the public share is being used in a computation. In some examples, the hash subkey (H) can similarly be divided into three secret shares (e.g., n=3) H₁, H₂, and H₃. In some aspects, the addition of additional hardware for generating n² the products increases the number of computations, silicon area, and/or power consumption in exchanged for increased security.

In some case, the architecture 700 can be used to obscure the secret shares H₁, H₂, and H₃ to prevent the secret shares H₁, H₂, and H₃ from being revealed in a side channel attack. However, even in the example of FIG. 7, each of the secret shares H₁, H₂, and H₃ is used three times (e.g., once with each public share a₁, a₂, a₃). In some cases, if there is no diversification within the computation modules 702, 704, 706, 708, 710, the computations can suffer from the issues of reuse of variables, self-similarity and/or lack of diffusion as described herein.

In the example of FIG. 7, computation modules 702, 704, 706, 708, 710 can perform a bi-linear computation on one of the public shares and one of the secret shares. In one illustrative example, the computation modules 702, 704, 706, 708, 710 can perform a 128-bit multiplication. As illustrated, computation module 702 receives public share a₃ and secret share H₃, the computation module 704 receives public share a₁ and secret share H₃, and the computation module 706 receives public share a₃ and secret share H₁.

As illustrated, the outputs of the computation modules 702, 704, 706 can be combined by an adder 712 (e.g., a bit-wise XOR) to generate a variable Z₂. Similarly, the outputs of computation modules 708 can be combined by an adder 714 to generate a variable Z₁ and the outputs of computation modules 710 can be combined by an adder 716 to generate a variable Z₃.

As shown in FIG. 7, the architecture 700 utilizes nine computation modules, which is equal to the number S of shares (e.g., S=three shares) squared. In some cases, increasing the number of computations by a factor of S² (e.g., S²=9) can be costly. However, distinct computation modules 702, 704, 706, 708, 710 can benefit from diversification to provide enhanced security. In some aspects, instead of nine distinct computation modules 702, 704, 706, 708, 710 as shown in FIG. 7, a single computation module (e.g., computation module 702) can be re-used with different inputs S² times in a serial fashion. In some aspects, using a single computation module to perform the S² computations serially can reduce the area used relative to distinct computation modules. However, in some cases, using a single computation module to perform the computations may not benefit from the structure diversification as described with respect to FIG. 6A.

FIG. 8A is a block diagram 800 illustrating an example structure of a bi-linear operation performed on a combination of public data and secret data. As illustrated, the block diagram includes secure components within a secure environment 802 (e.g., secure information storage 570, trusted execution environment 580, secure components 590. In some implementations, the secure environment 802 can include a computation module 806, security information asset storage 812 (e.g., security information asset storage device 102 of FIG. 1, secure information storage 570 of FIG. 5), duplication/masking/refresh module 814 (e.g., duplication/masking/refresh module 104 of FIG. 1), and duplication/masking module 816. As illustrated, a public environment 804 can include storage 808 (e.g., storage 210 of FIG. 2, system memory 1015, storage device 1030 of FIG. 10, memory 514 of FIG. 5). In some examples, the block diagram 800 can include a randomization module 810. As illustrated, the randomization module 810 can be included in the secure environment 802, public environment 804, and/or any combination thereof. As illustrated in FIG. 8A, the duplication/masking module 816 can obtain a public data variable A from the storage 808.

In some cases, the duplication/masking module 816 can obtain a random and/or pseudo-random number from the randomization module 810 that can be used to perform duplication and/or masking of the public variable A. For the purposes of illustration, the variable A can be represented as a i-bit wide vector Ai, where i is an integer. In some cases, the duplication/masking module 816 can output individual bits of a masked version of the vector Ai to the computation module 806.

In some cases, if the structure of different computation modules that perform the same computation as the computation module 806 are identical in structure to the computation module 806, an attacker may be able to decipher information about the secret key H based on the reuse of variables, self-similarity of operations, lack of diffusion, and/or any combination thereof.

As illustrated, the duplication/masking/refresh module 814 can obtain a secret key H from security information asset storage 812. In some cases, the duplication/masking/refresh module 814 can be similar to and perform similar functions as the duplication/masking/refresh module 104 of FIG. 1. As illustrated, the duplication/masking/refresh module 814 can output individual bits of a masked version of the secret key H to the computation module 806. For purposes of illustration, the secret key H can be represented as a j-bit wide vector, Hⱼ, where j is an integer.

As illustrated, the 806 includes a plurality of single-bit multiplication elements 818 that can multiply a single bit of the i-bit wide vector Aᵢ by a corresponding bit of the j-bit wide vector, Hj. In some cases, each single-bit multiplication element of the plurality of single-bit multiplication elements 818 can output a product to a chain of XOR gates 820. As illustrated, the structure of the plurality of single-bit multiplication elements 818 and XOR gates 820 can be highly structured. For example, the plurality of single-bit multiplication elements 818 and the XOR gates 820 can be arranged in a repeating pattern with a uniform spacing between elements and/or routing traces. In some implementations, adjacent multiplication elements and adjacent XOR gates can be assigned to the bits of the j-bit wide vector, Hⱼ and the bits of the i-bit wide vector Aᵢ in a pre-determined order. For example, as illustrated, the left-most multiplication element of the plurality of single-bit multiplication elements 818 can operate on bits H₀, A₀, the next adjacent multiplication element of the plurality of single-bit multiplication elements 818 can operate on bits H₁, A₁, and so-on.

FIG. 8B is a block diagram 850 illustrating an alternative example structure of a bi-linear operation performed on a combination of public data and secret data with enhanced security relative to the block diagram 800 of FIG. 8A. In the illustrative example of FIG. 8B, the public environment 804, storage 808, randomization module 810, security information asset storage 812, and duplication/masking/refresh module 814 can be similar to and perform similar functions to like numbered components of FIG. 8A. In the example of FIG. 8B, the duplication/masking module 816 and computation module 806 of FIG. 8A have been replaced by an alternative computation module 856 and a duplication/masking/randomization module 858.

In some implementations, the duplication/masking/randomization module 858 can perform the duplication/masking functions of duplication/masking module 816 of FIG. 8A. In some cases, the duplication/masking/randomization module 858 can add extra bits to the public variable A. In some cases, the dummy bits can be randomly generated (e.g., by a pseudorandom number generator (PRNG)), and/or derived from an internal state of a computing device (e.g., computing device 500 of FIG. 5).

As illustrated, the alternative computation module 856 can include a plurality of single-bit multiplication elements 818, as well as additional single-bit multiplication elements 819, 860. In the illustrated example, the additional single-bit multiplication elements 860 may use dummy bits Dₖ, where k is an integer, generated by duplication/masking/randomization module 858 in the place of bits from the public variable A and secret key H. In one illustrative example, the left-most additional single-bit multiplication element 860 in the alternative computation module 856 can generate a dummy product. In some examples, the dummy product can be generated by multiplication of two dummy bits of D₀*D₁. In some implementations, the dummy product can be generated by multiplication of a dummy bit D₀ and a bit of the public variable A₃. In some aspects, the dummy product can be generated by multiplication of a dummy bit Do and a variable derived from the public variable A and/or any other public variables available to the alternative computation module 856. As used herein, the outputs of additional single-bit multiplication elements 860 based on dummy bit inputs can be referred to as dummy products. In some aspects, the additional single-bit multiplication elements 860 In the illustrated example, products generated by additional single-bit multiplication elements 819 may use actual bits of the public variable A as input bits. As illustrated, in some cases, the dummy products can be combined with the products generated by additional single-bit multiplication elements 819 by XOR gates 862. In some cases, the outputs of the XOR gates 862 can in turn be provided to one of the XOR gates 820 for combination with the outputs of the plurality of single-bit multiplication elements 818. As illustrated, in some cases, by incorporating an even number of dummy products, the resulting output of the long XOR operation performed by the XOR gates 820 can be unchanged. However, the use of dummy products within the alternative computation module 856 can result in variations in power signature and/or timing of operations of the alternative computation module 856 relative to the computation module 806 of FIG. 8A.

In some cases, the alternative computation module 856 can incorporate structural diversification as described with respect to FIG. 6A above. For example, the arrangement of individual multiplication elements of the plurality of single-bit multiplication elements 818 and/or individual XOR gates of the XOR gates 820 can be different from the computation module 806 of FIG. 8A. As used herein, the term “computation elements” refers to individual logic gates included in a computation module. Illustrative examples of computational elements include, but are not limited to single-bit multiplication elements, XOR gates, Boolean logic gates, arithmetic computation modules, and/or any combination thereof.

In some examples, the order of inputs and/or outputs of adjacent multiplication elements 818, additional single-bit multiplication elements 819, and/or additional single-bit multiplication elements 860 can be randomized. In one illustrative example, each of the wires from the duplication/masking/refresh module 814 and duplication/masking/randomization module 858 input to the alternative computation module 856 can be defined as input wires. In the illustrative example, the output of multiplication elements 818, 819, and/or 860 can be defined as product wires. In some implementations, the randomly generated order (e.g., based on a PRNG seed) can be used to impose a pre-determined and strict fixed order for the input wires and/or the product wires. As illustrated in FIG. 8B, the order of computing the products for bits H₀, A₀ and bits H₁, A₁ have been swapped relative to the order illustrated in the computation module 806 of FIG. 8A. In some cases, the order of product wires input to the XOR gates 820 can be similar randomized as illustrated by the traces 821 swapping the order of inputs provided to the third and fourth XOR gates of the XOR gates 820. In some cases, randomizing the order of input wires and/or product wires within the alternative computation module 856 can result in variations in power signature and/or timing of operations of the alternative computation module 856 relative to the computation module 806 of FIG. 8A.

In some examples, (not shown), every sum of products (or a selected subset of the sums of products such as aᵢhⱼ+aₖhₗ) in a sequence of pairs of products can optionally be recoded with a dedicated shared random rⱼₗ as shown in Equation (3) below:

aᵢhⱼ+aₖhₗ=(aᵢ+aₖ)rⱼₗ+aᵢ(hⱼ+rⱼₗ)+aₖ(hₗ+rⱼₗ) (3)

In some cases, by implementing the recoding as shown in Equation (3), the number of district products that are not transformed can be reduced. As illustrated by Equation (3), the addition of the operations including the dedicated shared random rⱼₗ do not alter the outcome of the sum of products on the left-hand side of the equation aᵢhⱼ+aₖhₗ. In one illustrative example, 100 sums of products that would be produced without the transformation of Equation (3) could be reduced to approximately five distinct products a*hⱼ that are not transformed. In some cases, the value of the dedicated shared random rⱼₗ can be generated by the duplication/masking/randomization module 858. In some aspects, incorporating the computations of Equation (3) can result in variations in power signature and/or timing of operations of the alternative computation module 856 relative to the computation module 806 of FIG. 8A.

As noted above, the computing device 500 and related techniques described herein can allow a system to provide enhanced security for cryptographic components (e.g., cryptographic components 106 of FIG. 1, secure components 590 of FIG. 5). In some cases, the systems and techniques described herein can be used to enhance security for components performing linear and/or bi-linear computations. For example, the systems and techniques can enhance security for cryptographic components that perform a bi-linear operate on a public data and/or shares of public data as a first input and a secure key and/or shares of a secure key as a second input. In some cases, the systems and techniques can be used to provide diversification of structure in cryptographic components that perform an identical function. For example, diversification can include the use of different logic gates, transistors, routing, and/or any combination thereof. In some cases, diversification of structure can result in identical operations having different power signatures and/or timing between receiving inputs and generating outputs.

In some cases, the systems and techniques can include diversification based on providing dummy variables within the logic of a computation module that change the power signature and/or timing without affecting the generated output. For example, if a computation module performs a linear multiplication of a public key and a private key, a dummy product generating by multiplying by a dummy variable d in two different places within the computation module can change the power signature and/or timing of the operation performed by a computation module.

In some cases, the systems and techniques can include diversification based on locally derived random masks. In some cases, the use of locally derived random masks can significantly reduce the number of times a particular product of a public variable and a secret key is left untransformed (e.g., reducing reuse of variables).

In some cases, the systems and techniques can include diversification based on the inclusion of an even number of dummy products. In some cases, the systems and techniques can recode every sum of products in a sequence of pairs of products with a dedicated shared random.

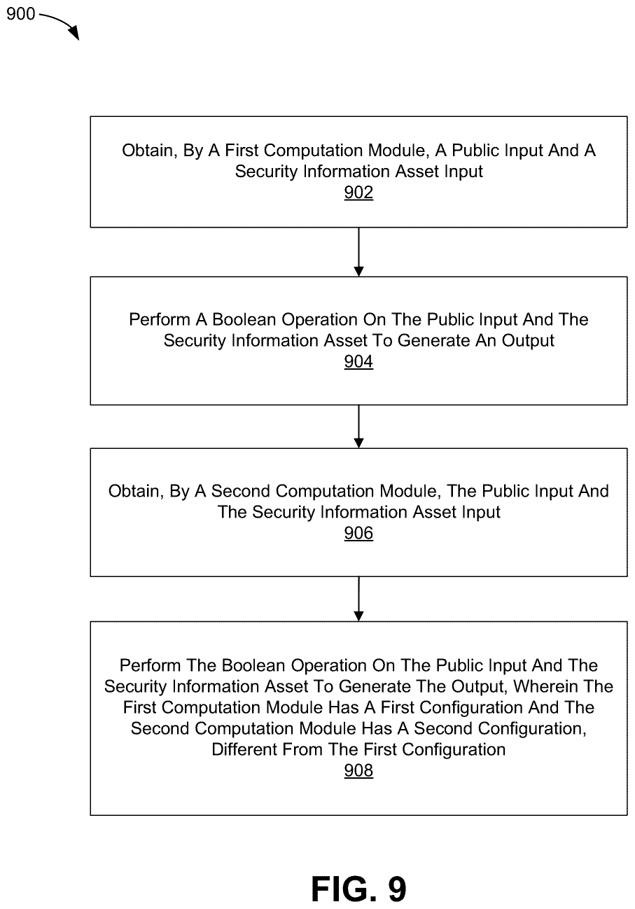

FIG. 9 is a flow diagram illustrating an example of a process 900 of securely performing cryptographic operations. The process 900 and/or other process described herein can be performed by a computing device (or apparatus) or a component (e.g., a chipset, codec, etc.) of the computing device. The computing device may be an extended reality (XR) device (e.g., a virtual reality (VR) device or augmented reality (AR) device), a mobile device (e.g., a mobile phone), a network-connected wearable such as a watch, a vehicle or component or system of a vehicle, or other type of computing device. In one example, the process 900 and/or other process described herein can be performed by the computing device 500 of FIG. 5. In another example, one or more of the processes can be performed by the computing system 1000 shown in FIG. 10. For instance, a computing device with the computing system 1000 shown in FIG. 10 can include the components of the computing device 500 and can implement the operations of the process 900 of FIG. 9 and/or other process described herein. The operations of the process 900 may be implemented as software components that are executed and run on one or more processors (e.g., the processor 1010 of FIG. 10, a processor such as a DSP, GPU, NPU, etc., or other processor(s)). Further, the transmission and reception of signals by the computing device in the process 900 may be enabled, for example, by one or more antennas, one or more transceivers (e.g., wireless transceiver(s)), and/or other communication components of the computing device (e.g., the communications interface 1040 of FIG. 10).

At block 902, the computing device (or component thereof) can obtain, by a first computation module (e.g., cryptographic components 106 of FIG. 1, computation modules 208 of FIG. 2, processor 510, secure information storage 570, trusted execution environment 580, secure components 590 of FIG. 5), a public input (e.g., a public key) and/or and a security information asset input (e.g., a secret key, secret key shares, a derived key). In some cases, each bit of the plurality of public bits has a fixed value.

At block 904, the computing device (or component thereof) can perform a Boolean operation (e.g., XOR, single bit multiplication), on the public input and the security information asset to generate an output. In some examples, the Boolean operation includes combining a plurality of public bits of the public data with a plurality of bits of the security information asset in a bi-linear computation.

At block 906, the computing device (or component thereof) can obtain, by a Second computation module, the public input and the security information asset input.

At block 908, the computing device (or component thereof) can perform the Boolean operation on the public input and the security information asset to generate the output. In some aspects, the first computation module has a first configuration and the second computation module has a second configuration, different from the first configuration

In some examples, the first configuration includes a first internal structure of the first computation module. In some cases, the second configuration includes a second internal structure of the second computation module. In some cases, the first computation module includes a first plurality of logic gates (e.g., single-bit multiplication elements 818, XOR gates 820 of FIG. 8A and FIG. 8B) and the second computation module includes a second plurality of logic gates. In some aspects, the first plurality of logic gates includes at least one logic gate that is different from any logic gates in the second plurality of logic gates (e.g., additional single-bit multiplication elements 860, XOR gates 862 of FIG. 8B).

In some implementations, the first computation module implements the Boolean operation with a first plurality of logic gates in a first configuration and the second computation module implementations the Boolean operation with a second plurality of logic gates in a second configuration, different from the first configuration.

In some examples, the public data and the security information asset obtained by the first computation module and the second computation module are masked (e.g., by refresh module 104 of FIG. 1).

In some cases, the second computation module is configured to generate an even number of dummy products during performance of the Boolean operation that are canceled out in the output generated by the second computation module.

In some aspects, the first computation module is configured to generate a plurality of products between bits of the public data and bits of the security information asset and generate a plurality of sums of products between pairs of products included in the plurality of products. In some cases, the plurality of sums of products can be recoded with a dedicated shared random variable.

In some implementations, the first computation module includes a plurality of computation elements configured to generate the output based on a pre-determined order of operations. In some examples, the pre-determined order of operations includes one or more of an order of calculating a plurality of products of bits of the public data with bits of the security information asset or an order of adding the plurality of products. In some cases, a pseudo random seed is expanded into a list that specifies the pre-determined order of operations. In some implementations, the plurality of computation elements includes single-bit multiplication elements. In some aspects, the single-bit multiplication elements comprise one or more of NAND gates or AND gates.

In some examples, the processes described herein (e.g., process 900 and/or any other process described herein) may be performed by a computing device or apparatus (e.g., a computing device 500 of FIG. 5). In another example, the process 900 may be performed by a computing device with the computing system 1000 shown in FIG. 10.

FIG. 10 is a diagram illustrating an example of a computing system for implementing certain aspects of the present technology. In particular, FIG. 10 illustrates an example of computing system 1000, which may be for example any computing device making up internal computing system, a remote computing system, a camera, or any component thereof in which the components of the system are in communication with each other using connection 1005. Connection 1005 may be a physical connection using a bus, or a direct connection into processor 1010, such as in a chipset architecture. Connection 1005 may also be a virtual connection, networked connection, or logical connection.

In some embodiments, computing system 1000 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example computing system 1000 includes at least one processing unit (CPU or processor) 1010 and connection 1005 that communicatively couples various system components including system memory 1015, such as read-only memory (ROM) 1020 and random access memory (RAM) 1025 to processor 1010. Computing system 1000 may include a cache 1012 of high-speed memory connected directly with, in close proximity to, or integrated as part of processor 1010. The example computing system 1000 also includes one or more cryptographical functional blocks 1011 connected to the processor 1010. For example, the one or more cryptographical functional blocks 1011 can include cryptographical blocks for performing, without limitation, NTT computations, matrix vector multiplication (A*y), r and r.G multiplication (e.g., elliptic curve point multiplication) events (e.g., for an elliptic curve digital signature algorithm (ECDSA)), security hash algorithms, (e.g., SHA-256, SHA-3), McEliece cryptography, bit flipping key encapsulation (BIKE), Hamming quasi-cycling (HQC) encryption, hash-based message authentication code (e.g., HMAC-512), RNG seeding. In some cases, multiple cryptographical functional blocks 1011 can be connected to one another directly or indirectly. In some implementations, the one or more cryptographical functional blocks 1011 can include one or more co-processing units.

Processor 1010 may include any general purpose processor and a hardware service or software service, such as services 1032, 1034, and 1036 stored in storage device 1030, configured to control processor 1010 as well as a special-purpose processor (e.g., an arithmetic processor, a cryptographic processor, and/or any combination thereof) where software instructions are incorporated into the actual processor design. Processor 1010 may essentially be a completely self-contained computing system, containing multiple cores or processors, a bus, memory controller, cache, etc. A multi-core processor may include distinct computation units of variable sizes and features. In some cases, a multi-core processor may be symmetric or asymmetric. In some examples, the one or more cryptographical functional blocks 1011 may be symmetric or asymmetric.

To enable user interaction, computing system 1000 includes an input device 1045, which may represent any number of input mechanisms, such as a microphone for speech, a touch-sensitive screen for gesture or graphical input, keyboard, mouse, motion input, speech, etc. Computing system 1000 may also include output device 1035, which may be one or more of a number of output mechanisms. In some instances, multimodal systems may enable a user to provide multiple types of input/output to communicate with computing system 1000.

Computing system 1000 may include communications interface 1040, which may generally govern and manage the user input and system output. The communications interface 1040 may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a Blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 1030 may include software services, servers, services, etc., that when the code that defines such software is executed by the processor 1010, it causes the system to perform a function. In some embodiments, a hardware service that performs a particular function may include the software component stored in a computer-readable medium in connection with the necessary hardware components, such as processor 1010, connection 1005, output device 1035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, nonvolatile memory express (NVMe) memory, Write Once Read Many (WORM) memory, electronic fuse (eFuse) one-time programmable (OTP), memory, I-fuse OTP memory, gate-oxide breakdown anti-fuse memory, Intel Optane memory, memory, or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communications interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communications interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. An apparatus for securely performing cryptographic operations comprising: a memory; and a processor coupled to the memory comprising: a first computation module configured to: obtain a public data and a security information asset; and perform a Boolean operation on the public data and the security information asset to generate an output; and a second computation module configured to: obtain the public data and the security information asset; and perform the Boolean operation on the public data and the security information asset to generate the output, wherein the first computation module has a first configuration and the second computation module has a second configuration, different from the first configuration.

Aspect 2. The apparatus of Aspect 1, wherein the Boolean operation comprises combining a plurality of public bits of the public data with a plurality of bits of the security information asset in a bi-linear computation.

Aspect 3. The apparatus of any of Aspects 1 to 2, wherein each bit of the plurality of public bits has a fixed value.

Aspect 4. The apparatus of any of Aspects 1 to 3, wherein the first configuration comprises a first internal structure of the first computation module and wherein the second configuration comprises a second internal structure of the second computation module.

Aspect 5. The apparatus of any of Aspects 1 to 4, wherein the first computation module implements the Boolean operation with a first plurality of logic gates in a first configuration and the second computation module implementations the Boolean operation with a second plurality of logic gates in a second configuration, different from the first configuration.

Aspect 6. The apparatus of any of Aspects 1 to 5, wherein the first computation module comprises a first plurality of logic gates and the second computation module comprises a second plurality of logic gates, wherein the first plurality of logic gates includes at least one logic gate that is different from any logic gates in the second plurality of logic gates.

Aspect 7. The apparatus of Aspect 6, wherein the at least one logic gate that is different from any logic gates in the second plurality of logic gates performs an identical function to one or more different logic gates included in the second plurality of logic gates.

Aspect 8. The apparatus of any of Aspects 1 to 7, wherein the public data and the security information asset obtained by the first computation module and the second computation module are masked.

Aspect 9. The apparatus of any of Aspects 1 to 8, wherein the second computation module is configured to generate an even number of dummy products during performance of the Boolean operation that are canceled out in the output generated by the second computation module.

Aspect 10. The apparatus of Aspect 9, wherein input data used for generating the even number of dummy products includes one or more of bits of public data or bits derived from bits of public data.

Aspect 11. The apparatus of any of Aspects 1 to 10, wherein the first computation module is configured to generate a plurality of products between bits of the public data and bits of the security information asset and generate a plurality of sums of products between pairs of products included in the plurality of products, wherein the plurality of sums of products can be recoded with a dedicated shared random variable.

Aspect 12. The apparatus of any of Aspects 1 to 11, wherein the first computation module comprises a plurality of computation elements configured to generate the output based on a pre-determined order of operations.

Aspect 13. The apparatus of Aspect 12, wherein the pre-determined order of operations comprises one or more of an order of calculating a plurality of products of bits of the public data with bits of the security information asset or an order of adding the plurality of products.

Aspect 14. The apparatus of Aspect 12, wherein a pseudo random seed is expanded into a list that specifies the pre-determined order of operations.

Aspect 15. The apparatus of Aspect 12, wherein the plurality of computation elements comprises single-bit multiplication elements, wherein the single-bit multiplication elements comprise one or more of NAND gates or AND gates.

Aspect 16. The apparatus of Aspect 12, wherein the plurality of computation elements comprises XOR gates.

Aspect 17. The apparatus of any of Aspects 1 to 16, further comprising an additional processor coupled to the memory, wherein the additional processor comprises a third computation module configured to: obtain the public data and the security information asset; and perform the Boolean operation on the public data and the security information asset to generate the output, wherein the third computation module has a third configuration, different from the first configuration.

Aspect 18. A method for securely performing cryptographic operations comprising: obtaining a public data and a security information asset; performing, by a first computation module, a Boolean operation on the public data and the security information asset to generate an output; obtaining the public data and the security information asset; and performing, by a second computation module, the Boolean operation on the public data and the security information asset to generate the output, wherein the first computation module has a first configuration and the second computation module has a second configuration, different from the first configuration.

Aspect 19. The method of Aspect 18, wherein the Boolean operation comprises combining a plurality of public bits of the public data with a plurality of bits of the security information asset in a bi-linear computation.

Aspect 20. The method of any of Aspects 18 to 19, wherein each bit of the plurality of public bits has a fixed value.

Aspect 21. The method of any of Aspects 18 to 20, wherein the first configuration comprises a first internal structure of the first computation module and wherein the second configuration comprises a second internal structure of the second computation module.

Aspect 22. The method of any of Aspects 18 to 21, wherein the first computation module implements the Boolean operation with a first plurality of logic gates in a first configuration and the second computation module implementations the Boolean operation with a second plurality of logic gates in a second configuration, different from the first configuration.

Aspect 23. The method of any of Aspects 18 to 22, wherein the first computation module comprises a first plurality of logic gates and the second computation module comprises a second plurality of logic gates, wherein the first plurality of logic gates includes at least one logic gate that is different from any logic gates in the second plurality of logic gates.

Aspect 24. The method of Aspect 23, wherein the at least one logic gate that is different from any logic gates in the second plurality of logic gates performs an identical function to one or more different logic gates included in the second plurality of logic gates.

Aspect 25. The method of any of Aspects 18 to 24, wherein the public data and the security information asset obtained by the first computation module and the second computation module are masked.

Aspect 26. The method of any of Aspects 18 to 25, wherein the second computation module is configured to generate an even number of dummy products during performance of the Boolean operation that are canceled out in the output generated by the second computation module.

Aspect 27. The method of Aspect 26, wherein input data used for generating the even number of dummy products includes one or more of bits of public data or bits derived from bits of public data.

Aspect 28. The method of any of Aspects 18 to 27, wherein the first computation module is configured to generate a plurality of products between bits of the public data and bits of the security information asset and generate a plurality of sums of products between pairs of products included in the plurality of products, wherein the plurality of sums of products can be recoded with a dedicated shared random variable.

Aspect 29. The method of any of Aspects 18 to 28, wherein the first computation module comprises a plurality of computation elements configured to generate the output based on a pre-determined order of operations.

Aspect 30. The method of Aspect 29, wherein the pre-determined order of operations comprises one or more of an order of calculating a plurality of products of bits of the public data with bits of the security information asset or an order of adding the plurality of products.

Aspect 31. The method of Aspect 29, wherein a pseudo random seed is expanded into a list that specifies the pre-determined order of operations.

Aspect 32. The method of Aspect 29, wherein the plurality of computation elements comprises single-bit multiplication elements, wherein the single-bit multiplication elements comprise one or more of NAND gates or AND gates.

Aspect 33. The method of Aspect 29, wherein the plurality of computation elements comprises XOR gates.

Aspect 34. A non-transitory computer-readable storage medium having stored thereon instructions which, when executed by one or more processors, cause the one or more processors to perform any of the operations of aspects 1 to 33.

Aspect 35. An apparatus comprising means for performing a method according to any of Aspects 1 to 33.

What is claimed is:

1. An apparatus for securely performing cryptographic operations comprising:
a memory; and
a processor coupled to the memory comprising:
a first computation module configured to:
obtain a public data and a security information asset; and
perform a Boolean operation on the public data and the security information asset to generate an output; and
a second computation module configured to:
obtain the public data and the security information asset; and
perform the Boolean operation on the public data and the security information asset to generate the output, wherein the first computation module has a first configuration and the second computation module has a second configuration, different from the first configuration.

2. The apparatus of claim 1, wherein the Boolean operation comprises combining a plurality of public bits of the public data with a plurality of bits of the security information asset in a bi-linear computation.

3. The apparatus of claim 2, wherein each bit of the plurality of public bits has a fixed value.

4. The apparatus of claim 3, wherein the first configuration comprises a first internal structure of the first computation module and wherein the second configuration comprises a second internal structure of the second computation module.

5. The apparatus of claim 1, wherein the first computation module implements the Boolean operation with a first plurality of logic gates in a first configuration and the second computation module implementations the Boolean operation with a second plurality of logic gates in a second configuration, different from the first configuration.

6. The apparatus of claim 1, wherein the first computation module comprises a first plurality of logic gates and the second computation module comprises a second plurality of logic gates, wherein the first plurality of logic gates includes at least one logic gate that is different from any logic gates in the second plurality of logic gates.

7. The apparatus of claim 6, wherein the at least one logic gate that is different from any logic gates in the second plurality of logic gates performs an identical function to one or more different logic gates included in the second plurality of logic gates.

8. The apparatus of claim 1, wherein the public data and the security information asset obtained by the first computation module and the second computation module are masked.

9. The apparatus of claim 1, wherein the second computation module is configured to generate an even number of dummy products during performance of the Boolean operation that are canceled out in the output generated by the second computation module.

10. The apparatus of claim 9, wherein input data used for generating the even number of dummy products includes one or more of bits of public data or bits derived from bits of public data.

11. The apparatus of claim 1, wherein the first computation module is configured to generate a plurality of products between bits of the public data and bits of the security information asset and generate a plurality of sums of products between pairs of products included in the plurality of products, wherein the plurality of sums of products can be recoded with a dedicated shared random variable.

12. The apparatus of claim 1, wherein the first computation module comprises a plurality of computation elements configured to generate the output based on a pre-determined order of operations.

13. The apparatus of claim 12, wherein the pre-determined order of operations comprises one or more of an order of calculating a plurality of products of bits of the public data with bits of the security information asset or an order of adding the plurality of products.

14. The apparatus of claim 12, wherein a pseudo random seed is expanded into a list that specifies the pre-determined order of operations.

15. The apparatus of claim 12, wherein the plurality of computation elements comprises single-bit multiplication elements, wherein the single-bit multiplication elements comprise one or more of NAND gates or AND gates.

16. The apparatus of claim 12, wherein the plurality of computation elements comprises XOR gates.

17. The apparatus of claim 1, further comprising an additional processor coupled to the memory, wherein the additional processor comprises a third computation module configured to:
obtain the public data and the security information asset; and
perform the Boolean operation on the public data and the security information asset to generate the output, wherein the third computation module has a third configuration, different from the first configuration.

18. A method for securely performing cryptographic operations comprising:
obtaining a public data and a security information asset;
performing, by a first computation module, a Boolean operation on the public data and the security information asset to generate an output;
obtaining the public data and the security information asset; and
performing, by a second computation module, the Boolean operation on the public data and the security information asset to generate the output, wherein the first computation module has a first configuration and the second computation module has a second configuration, different from the first configuration.

19. The method of claim 18, wherein the Boolean operation comprises combining a plurality of public bits of the public data with a plurality of bits of the security information asset in a bi-linear computation.

20. The method of claim 19, wherein each bit of the plurality of public bits has a fixed value.

21. The method of claim 20, wherein the first configuration comprises a first internal structure of the first computation module and wherein the second configuration comprises a second internal structure of the second computation module.

22. The method of claim 18, wherein the first computation module implements the Boolean operation with a first plurality of logic gates in a first configuration and the second computation module implementations the Boolean operation with a second plurality of logic gates in a second configuration, different from the first configuration.

23. The method of claim 18, wherein the first computation module comprises a first plurality of logic gates and the second computation module comprises a second plurality of logic gates, wherein the first plurality of logic gates includes at least one logic gate that is different from any logic gates in the second plurality of logic gates.

24. The method of claim 23, wherein the at least one logic gate that is different from any logic gates in the second plurality of logic gates performs an identical function to one or more different logic gates included in the second plurality of logic gates.

25. The method of claim 18, wherein the public data and the security information asset obtained by the first computation module and the second computation module are masked.

26. The method of claim 18, wherein the second computation module is configured to generate an even number of dummy products during performance of the Boolean operation that are canceled out in the output generated by the second computation module.

27. The method of claim 26, wherein input data used for generating the even number of dummy products includes one or more of bits of public data or bits derived from bits of public data.

28. The method of claim 18, wherein the first computation module is configured to generate a plurality of products between bits of the public data and bits of the security information asset and generate a plurality of sums of products between pairs of products included in the plurality of products, wherein the plurality of sums of products can be recoded with a dedicated shared random variable.

29. The method of claim 18, wherein the first computation module comprises a plurality of computation elements configured to generate the output based on a pre-determined order of operations.

30. The method of claim 29, wherein the pre-determined order of operations comprises one or more of an order of calculating a plurality of products of bits of the public data with bits of the security information asset or an order of adding the plurality of products.
